(19) United States
(12) Patent Application Publication
(10) Pub. No.: US 2003/0131886 A1
(43) Pub. Date: Jul. 17, 2003

(54) Automatic wastewater pipe cleaning system

(76) Inventor: Keith E. Walker, (US)

Correspondence Address: JOHN M. BRANDT, 60 THAXTER ST., HINGHAM, MA, 02043, US

(21) Appl. No.: 10/053,893

(22) Filed: Jan. 14, 2002

(51) Int. Cl. F16K 3/36

(52) U.S. Cl. 137/240

(57) ABSTRACT

An automatic wastewater pipe flushing, unclogging, and blockage removal system consisting of a source of compressed gas connected to and releasable into the pipe and release control apparatus including a sensor to detect water backup and a valve operated by the sensor to provide a burst of compressed gas into the pipe in the region of and upstream from the blockage. A timer may be included to regulate the duration of the burst.

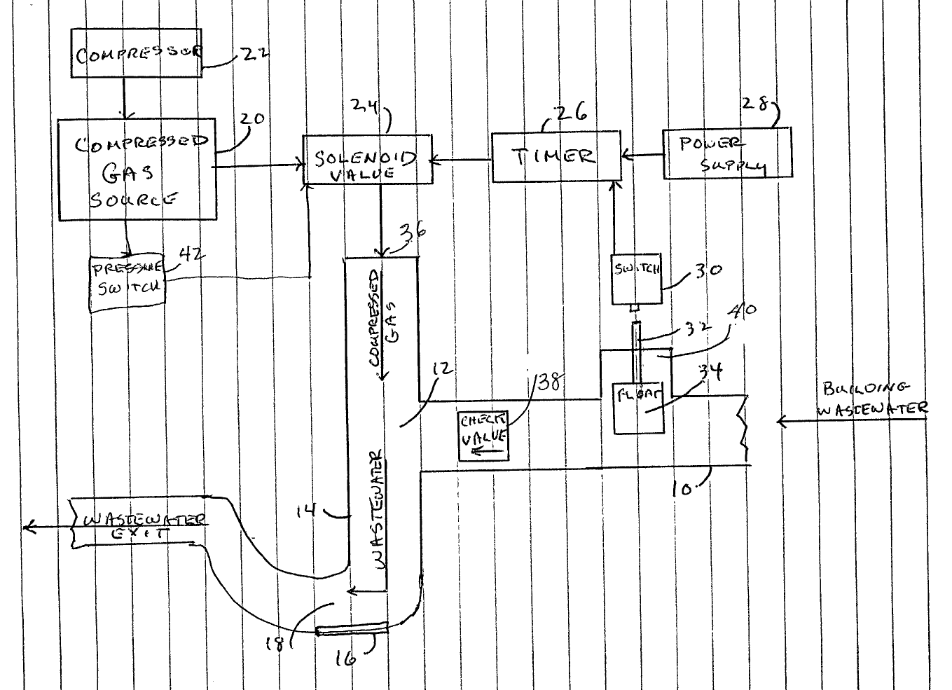

### BACKGROUND OF THE INVENTION

1. Field of the Invention

The invention relates to devices employed for flushing, unclogging, and removing blockages from wastewater pipes and more particularly relates to arrangements utilizing compressed gas to accomplish this purpose.

2. Description of the Prior Art

Wastewater disposal plumbing for buildings can accumulate foreign substances which, after a period of time, will cause blockages within the piping leading to overflows and subsequent water damage to the building structure and contents. This is particularly true of systems receiving the discharge of air conditioning units which promote the build up of organic substances such as fungus and algae as well as rust particles and other debris.

Units employing compressed or pressurized gas or water which is released near a clog to dislodge a blockage are known in the prior art. For example, U.S. Pat. No. 4,063,317, Santore, discloses a gas storage chamber pressurized to a desired pressure and then released by hand into a blocked pipe. U.S. Pat. No. 5,530,988, McQuillan, shows a similar device also hand released. Further, the invention of U.S. Pat. No. 5,085,244, Funk, utilizes an alternating combination of pressure and vacuum while U.S. Pat. N0. 4,555,820, Dragstream, provides for pressurized water and an anti-backflow device. Finally, U.S. Pat. No. 5,188,134, Satoh et al, uses a high pressure water hose with a rotatable nozzle which is introduced directly into the pipe itself

Non of the devices known to the inventors disclose any means for activating a cleaning or blockage removal system automatically upon the occurrence of a clog which will result in wastewater backup, subsequent overflow from drains, sinks, or toilets and consequential cosmetic and structural damage to the building concerned.

In contrast to the prior art, the present invention provides a blockage detection mechanism linked removal apparatus whereby the harmful effects of water backup may be avoided.

### SUMMARY OF THE INVENTION

The invention may be summarized as an automatic system for flushing and unclogging a wastewater pipe by releasing a burst of compressed gas upstream from a site in the pipe where a blockage is likely to occur. A float is disposed in the pipe upstream from the point of introduction of the gas and is arranged to rise as wastewater backs up as a result of a blockage. The float communicates with and activates an electrical switch which in turn operates a solenoid valve positioned to admit the compressed gas to relieve the obstruction. The burst will continue until the source is exhausted or optionally a timer which may have a variable and controllable duration can be used to close the solenoid after a selected period.

A check valve interposed between the float and the point of introduction of the compressed gas prevents the gas from traveling upstream towards the float and directs all of the pressure downstream to the blockage. The source of the gas can be either a pre-pressurized canister or may include a compressor to restore the source to an effective pressure after a cleaning cycle.

These and other features and advantages of the invention will become more evident from the description of the preferred embodiment and drawing which follow.

### DESCRIPTION OF THE DRAWING

The figure is a schematic representation of the preferred embodiment of the invention

### DESCRIPTION OF THE PREFERRED EMBODIMENT

Referring to the figure, there is shown in schematic format the wastewater pipe cleaning system which constitutes the preferred embodiment of the invention. Building wastewater pipe 10 conveys wastewater to location or junction 12 in wastewater exit pipe 14 which most commonly includes a cleanout 16 in trap 18. This is an area which might be expected to accumulate foreign substances to the extent of creating a blockage stopping the outward flow of the wastewater continually being generated within the building. This wastewater will, if the blockage is not removed, back up and overflow from, for example, sink drains eventually resulting in substantial cosmetic and structural damage.

A source of compressed gas 20 is arranged to deliver a burst of gas to pipe 14 at a position upstream from location 12. The source may be an independently pressurized container or may be pressurized on site from ,for example, compressor 22. Delivery of the gas is controlled by solenoid valve 24 and may be of a selected duration set by timer 26 switching power supply 28. Actuation of timer 26 is controlled by switch 30, a micro switch for example, which is in turn activated by pressure from rod 32 connected to float 34 disposed in pipe 10.

In operation, a blockage in exit pipe 14 will cause pipe 10 to fill beyond normal flow levels raising float 34 and rod 32 to trigger switch 30 actuating solenoid valve 24 releasing a burst of compressed gas into pipe 14 at junction 36. Check valve 38 prevents the flow of the gas back into pipe 10 directing the full force of the gas burst into exit pipe 14

Variations in the above described automatic system will now be apparent to those skilled in the art. For example, an extension chamber 40 in pipe 10 may optionally be used to provide a greater degree of upward travel for float 34 to reduce the chance of activation due to heavy wastewater flow rather than back up from a downstream clog. Further, timer 26 may be adjustable to provide different burst durations according to the conditions present in a particular building. Additionally, the timer may be eliminated entirely and a pressure switch 42 utilized to close solenoid valve 24 when the pressure in source 20 is reduced below a selected level. Accordingly, the invention is therefore defined by the following claims.

What is claimed is:

1. Apparatus for cleaning a wastewater pipe of blockages and foreign debris buildup comprising in combination:
a. A source of compressed gas connected to said wastewater pipe at a selected connection location;
b. An electrically operated solenoid valve interposed between said source and said connection location;
c. A check valve positioned in said wastewater pipe upstream from said connection location, said valve arranged to pass wastewater downstream to said location and to prevent the flow of said gas upstream from said location;
d. A float positioned in said wastewater pipe upstream from said location; and
e. An electrical switch operatively connected to said solenoid valve and communicating with said float whereby when said wastewater pipe is blocked downstream from said connection location, wastewater will fill said pipe upstream from said check valve, said float will rise, said solenoid will be activated, and a burst of compressed gas will enter said pipe at said connection location.

2. The apparatus of claim 1 further including a timer interposed between said switch and said solenoid valve for controlling the duration of said burst of compressed gas.

3. The apparatus of claim 1 further including an expanded chamber in said pipe for receiving said float.

4. The apparatus of claim 3 wherein the top of said chamber has a port and further includes a shaft extending from said float through said port to communicate with said switch.
